(19) United States
(12) Patent Application Publication
(10) Pub. No.: US 2016/0007570 A1
(43) Pub. Date: Jan. 14, 2016

(54) PET HARNESS WITH UNIQUE LEASH CONNECTOR

(71) Applicant: Coastal Pet Products, Inc., Alliance, OH (US)

(72) Inventor: James G. STOUT, Alliance, OH (US)

(21) Appl. No.: 14/326,799

(22) Filed: Jul. 9, 2014

(51) Int. Cl. A01K 27/00; A44B 11/25

(52) U.S. Cl. CPC A01K 27/002; A44B 11/25

(57) ABSTRACT

A pet harness (10) is made up of a plurality of straps (12, 13, 14) and a chest pad (11). The back strap (14) is formed of two sections (22, 23) which are attached by a buckle (25). A leash connector (30), which includes two brackets (31), is carried by the back strap (14). Each bracket (31) has a portion (33) which has an aperture (37) therein. When the brackets (31) are pivoted such that the portions (33) mate with each other, a snap connector of a leash may be attached through the aligned apertures (37). When access to the buckle (25) is desired, the brackets (31) may be pivoted away from each other when not connected to the leash.

### TECHNICAL FIELD

This invention relates to harnesses or the like, such as those used to train or walk dogs. More specifically, this invention relates to such a harness which has a unique leash connector located at the back or withers of the dog.

### BACKGROUND ART

Pet or dog collars or harnesses which are connectable to a leash have long been used to control or otherwise train the dog while walking with it. Typically, the leash is connected to a ring carried by the collar or by a harness at the withers or back of the dog. It is also desirable to provide a harness with a leash connector at the front or chest of the dog to assist in training the dog. That is, when the leash is connected to the front of the dog, a pull on the leash will tend to turn the dog alerting it that something that it is doing may not be desirable.

When a leash connector is so positioned on the front of the harness, the conventional quick disconnect buckle for the harness is typically positioned on the harness at the back or withers of the dog. However, it is also desirable to position a leash connector at that location which provides the harness with the advantage of being able to connect the leash selectively at two different locations. But providing both a leash connector and a buckle at the same location is problematic. When a leash connecting ring is placed at one side of the buckle, undue stress is placed on the buckle. In an attempt to solve that problem, a ring was placed on each side of the buckle, and when it was desired to attach a leash at that location, the rings needed to somehow be held together and then the snap connector on the leash had to engage both rings. Such was not easy to accomplish particularly when the harness was being worn by an active pet.

Thus, the need exists for a collar or a harness having a leash connector and a quick disconnect buckle at the same location on the dog.

### DISCLOSURE OF THE INVENTION

It is thus an object of one aspect of the present invention to provide a pet product with a leash connector located at the same location as a buckle.

It is an object of another aspect of the present invention to provide a pet product, as above, with a two piece leash connector, one piece being located on each side of the buckle.

It is an object of an additional aspect of the present invention to provide a pet product, as above, in which the two pieces of the leash connector have portions which are readily mateable to be engaged by the snap connector of a leash.

It is an object of yet another aspect of the present invention to provide a pet product, as above, which removes any stress from the buckle.

These and other objects of the present invention, as well as the advantages thereof over existing prior art forms, which will become apparent from the description to follow, are accomplished by the improvements hereinafter described and claimed.

In general, a pet product made in accordance with the present invention is adapted to be connected to the snap connector of a leash and includes a strap. The strap has a first portion and a second portion. A leash connector includes a first bracket connected to the first portion of the strap and a second bracket connected to the second portion of the strap. Each bracket has an opening such that when the openings of the brackets are aligned, the snap connector of the leash can engage the brackets through the openings.

In accordance with another aspect of the invention, an apparatus for enabling the connection of a leash to a harness or the like includes a first bracket having a first portion adapted to be connected to the harness and a second portion having an opening thereon. A second bracket has a first portion adapted to be connected to the harness and a second portion having an opening thereon. The openings of the second portions are adapted to be aligned for connection to the leash.

A preferred exemplary harness and leash connector according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a harness made in accordance with the present invention.

FIG. 2 is a fragmented elevational view of the leash connector of the present invention showing the brackets which form the two portions thereof mated with each other to receive the snap connector of a leash.

FIG. 3 is a view similar to FIG. 2 but showing the brackets pivoted away from each other for access to the buckle.

FIG. 4 is a perspective view of a bracket which, with an identical bracket, make up the leash connector.

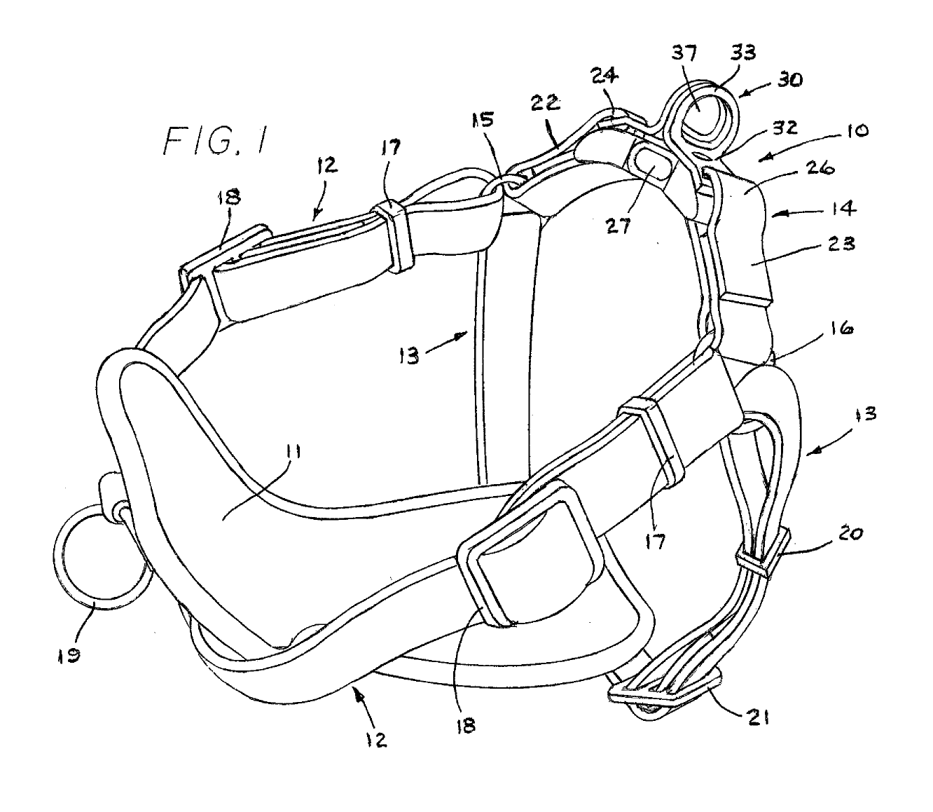

### PREFERRED EMBODIMENT FOR CARRYING OUT THE INVENTION

The present invention is shown as being used on a harness generally indicated by the numeral 10. Harness 10 is intended to be used primarily with a dog, but it could be used in conjunction with the restraint and control of other animals. Moreover, the invention described herein could be utilized with a pet collar. However, the discussion herein will discuss its use on a harness for a dog.

Harness 10 includes a chest pad 11, a neck strap generally indicated by the numeral 12, a girth strap generally indicated by the numeral 13, and a withers or back strap generally indicated by the numeral 14.

Neck strap 12 extends at one end from a ring 15, slideably through a pocket (not shown) near the top of the front of chest pad 11, and terminates at its other end at a ring 16. Slides 17 may be provided to tighten the loop connection of neck strap 12 to rings 15 and 16. In addition, conventional slide adjusters 18 may be provided on neck strap 12 to enable the adjustment of the length thereof as is known in the art. An opening (not shown) at the center of the pocket in the pad 11 allows a leash connecting ring 19 to be carried by neck strap 12.

Girth strap 13 extends at one end from ring 15, slidably through a pocket (not shown) near the bottom of the front of the chest pad 11, and terminates at its other end at ring 16. Thus, neck strap 12 and girth strap 13 effectively carry chest pad 11 in the proper position. A slide 20 may be provided to tighten the loop connection of girth strap 13 to ring 16, and a conventional slide adjustor 21 may be provided to enable the adjustment of the length of girth strap 13.

Withers strap 14 is formed in two sections 22 and 23. Section 22 extends from ring 15 and is looped, as at 24, around one end of a conventional side release locking buckle or clasp 25. Similarly, section 23 extends from ring 16 and is looped, as at 26, around the other end of buckle 25.

Buckle 15 includes side tabs 27 (one shown) which, when depressed, allows buckle 25 to be opened so that harness 10 can be positioned on a dog. To that end, the front legs of the dog are positioned through the open area between pad 11, neck strap 12 and girth strap 13. Then the buckle 25 may be utilized to attach sections 22 and 23 of withers strap 14. As such, harness 10 is positioned on the dog with pad 11 extending along the chest of the dog, strap 12 extending around its neck, strap 13 underneath the legs of the dog, and strap 14 being positioned on its back. The snap connector of a leash may then be attached to ring 19 for control of the dog. However, if it is desired to provide a second possible connection for the snap connector of a leash on the withers strap 14, such can be accomplished without interfering with the use of buckle 25 and without putting undo stress on the buckle by means of the leash connector assembly made in accordance with the present invention and generally indicated by the numeral 30, now to be described.

Leash connector assembly 30 is made of two portions or brackets generally indicated by the numeral 31. Brackets 31 are preferably made of a metallic material and are shown as being identical in construction. As such, each bracket has a base portion 32, a leash connector portion 33 extending upwardly from base portion 32 at a right angle of approximately ninety degrees, and a strap connector portion 34 extending downwardly from base portion 32 at an acute angle of preferably less than forty-five degrees. Base portion 32 may be provided with a small opening 35 for the purpose of removing weight from a portion which need not be totally solid.

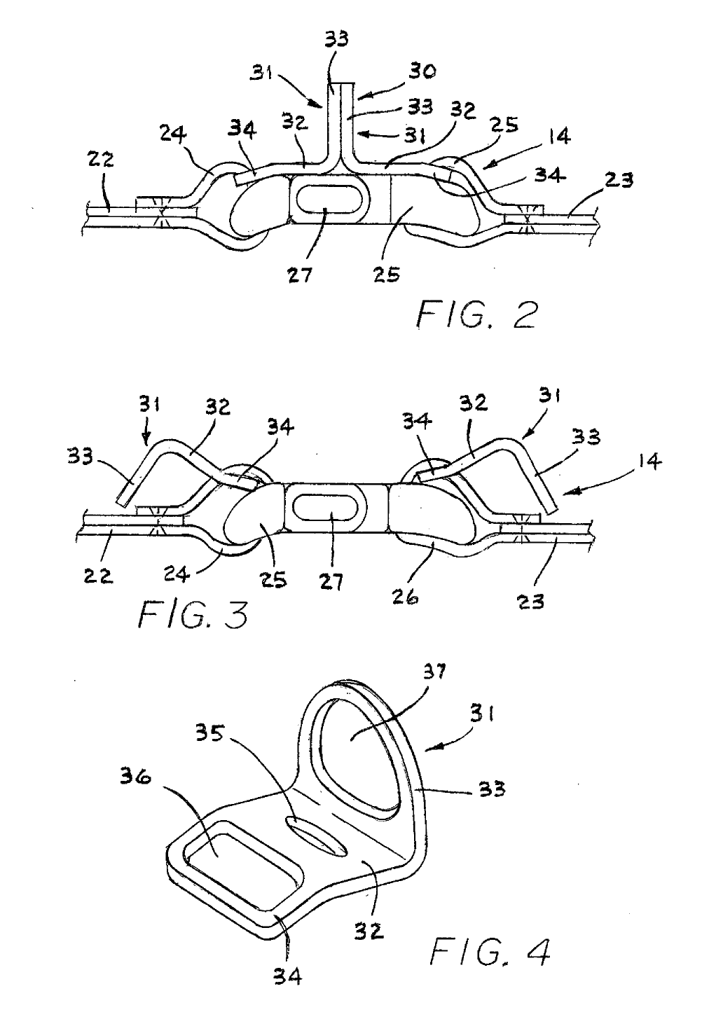

Strap connector portion 34 of each bracket 31 is provided with a generally rectangular aperture or opening 36. Such enables brackets 31 to be carried by withers strap 14. As such, loop 24 of strap section 22 is received by opening 36 of one bracket 31, and loop 26 of strap section 23 is received by opening 36 of the other bracket 31. Such allows brackets 31 to be pivoted from the FIG. 2 position, where leash connector portions 33 of brackets 31 mate each other, to the FIG. 3 position where the brackets 31 extend over strap sections 22 and 23 to exposed buckle 25.

Leash connector portion 33 of each bracket 31 includes an aperture or opening 37 which is shown as being circular but which could be of any suitable shape. When portions 33 are positioned adjacent to each other, or otherwise mate with each other, as shown in FIG. 2, openings 37 are aligned and thus the snap hook of a leash may engage both brackets 31 by extending through the openings 37 thereof. Such provides the user with the option of connecting a leash to the ring 19 at the chest of the dog or connecting it to bracket portions 33 on the back of the dog. It should be evident that when access to clasp 25 is desired to remove the harness from the dog, the leash may be removed and brackets 31 may be pivoted from the FIG. 2 to the FIG. 3 position to expose clasp 25.

In light of the foregoing, it should thus be evident that a harness constructed as described herein substantially improves the art and otherwise accomplishes the objects of the present invention.

What is claimed is:

1. A pet product adapted to be connected to a snap connector of a leash comprising a strap having a first portion and a second portion; and a leash connector, said leash connector including a first bracket connected to said first portion of said strap, and a second bracket connected to said second portion of said strap, each said bracket having an opening such that when said openings of said brackets are aligned, the snap connector of the leash can engage said brackets through said openings.

2. The product of claim 1 wherein each said bracket includes a base portion and a strap connector portion extending from said base portion, said strap connector portion having an aperture therein to receive said strap.

3. The product of claim 2 wherein each said bracket includes a leash connector portion extending from said base portion and having said opening.

4. The harness of claim 3 wherein said strap connector portion extends from said base portion at an acute angle, and said leash connector portion extends from said base portion at substantially a right angle.

5. The product of claim 1 wherein each said bracket includes a base portion and a leash connector portion extending from said base portion, said leash connector portion having said opening.

6. The product of claim 1 wherein said first bracket is pivotally connected to said first portion of said strap and said second bracket is pivotally connected to said second portion of said strap.

7. The product of claim 1 further comprising a buckle extending between said first and second portions of said strap.

8. The product of claim 1 further comprising first and second rings, said first portion of said strap being attached to said first ring and said second portion of said strap being attached to said second ring.

9. The product of claim 8 further comprising a neck strap extending between said rings and a girth strap extending between said rings.

10. The product of claim 9 further comprising a chest pad carried by said neck strap and said girth strap.

11. The product of claim 10 further comprising a third ring positioned adjacent to said chest pad and adapted to receive a snap connector of a leash.

12. Apparatus for enabling the connection of a leash to a harness or the like comprising a first bracket having a first portion adapted to be connected to the harness and a second portion having an opening therein, a second bracket having a first portion adapted to be connected to the harness and a second portion having an opening therein, said openings of said second portions being adapted to be aligned for connection to the leash.

13. The apparatus of claim 12 wherein said first portion of each said bracket has an opening therein to receive the harness.

14. The apparatus of claim 13 wherein each said bracket includes a base portion, said first portion extending from one side of said base portion and said second portion extending from the other side of said base portion of each said bracket.

15. The apparatus of claim 14 wherein said first portion of each said bracket extends from said base portion of each said bracket at an acute angle and said second portion of each said bracket extends from said base portion of each said bracket at substantially a right angle.

16. The apparatus of claim 15 wherein said brackets are substantially identical in configuration.
